(19) United States
(12) Patent Application Publication
(10) Pub. No.: US 2008/0013171 A1
(43) Pub. Date: Jan. 17, 2008

(54) Fresnel Lens Sheet, Rear Projection Type Screen and Rear Projection Type Image Display Unit

(75) Inventors: Yoshihiro Kumagai, Niigata Pref (JP); Youji Ono, Niigata Pref (JP); Masanori Ogino, Kanagawa Pref (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KURARAY CO., LTD., OKAYAMA (JP)

(21) Appl. No.: 11/628,221

(22) PCT Filed: May 24, 2005
(86) PCT No.: PCT/JP05/09410

§ 371 Date: Dec. 1, 2006

(30) Foreign Application Priority Data
Jun. 1, 2004 (JP) 2004-163271

(51) Int. Cl. G03B 21/60

(52) U.S. Cl. 359/457

(57) ABSTRACT

[PROBLEMS] A method of producing a precision, low-cost resin molded article capable of improving a light utilizing efficiency and reducing a stray light caused by a light that enters a rise surface and is reflected off a reflection surface in an abnormal direction or refracted.

[MEANS OF SOLVING PROBLEMS] A Fresnel lens sheet which comprises a prism row that is provided on the incident-side surface of the Fresnel lens sheet to deflect an incident light toward an exit side, at least part of the prism row having an incident surface for refracting an incident light from a light source, a reflection surface for totally reflecting light beam refracted at the incident surface, and a rise surface between the center-side terminal point of the incident surface and the outer periphery-side terminal point of the reflection surface, the three surfaces, that is the reflection surface, the incident surface and the rise surface constituting one unit of prism, characterized in that the rise surface is reversely tilted toward the outer periphery side starting at the crossing point between the incident surface and the rise surface, and a Fresnel light axis center portion is formed eccentrically so as to fall outside a lens sheet range.

### TECHNICAL FIELD

The present invention relates to a Fresnel lens sheet applied to optical products such as a rear projection type screen.

### BACKGROUND ART

Generally, a projection screen is configured by a Fresnel lens sheet and a lenticular lens sheet and is an article for imaging an image on the projection screen by a video light from a projector and acquiring a directive diffusing surface.

A conventional type Fresnel lens has a configuration that serrate irregularities (a prism) are arranged in a row on a concentric circle, an incident light is refracted by the tilted prism, and the whole sheet functions as a lens.

FIG. 8 shows the whole projector including a sectional view of an exit surface refraction type Fresnel lens sheet used for a standard of a conventional type rear projection type screen. A reference numeral 102 in FIG. 8 denotes a projector for a projection light source, 113 denotes the Fresnel lens sheet, an alternate long and short dash line denotes an optical axis, and the optical axis is matched with the center of concentric Fresnel lens structure.

FIG. 9 is a perspective view showing the conventional type Fresnel lens sheet corresponding to FIG. 8. A reference numeral 115 denotes the center of Fresnel zones and 113 denotes the rectangular lens sheet.

As for the manufacture of the Fresnel lens, a metal mold is cut by a cutting tool, the metal mold and a copied mold are used for a mold, and press molding, injection molding and molding by an ultraviolet-hardening agent are generally performed.

Recently, in order to reduce the depth of a projection television set, an angle (an angle of view) at which a video light is incident on a Fresnel lens has a tendency to be increased. To further reduce the depth of the projection television set or to large-size a screen, it is proposed that a video light is diagonally incident on the screen and its angle also has a tendency to be increased year by year. However, a Fresnel lens using conventional type refractive action has a limit in refracting power and cannot sufficiently deflect the incident light.

To solve the problem, Patent Document 1 and technique using a total reflection principle on the side of an incident surface of a sheet are disclosed. Concretely, as shown in FIG. 5, a Fresnel lens sheet where a prism row configured by two surfaces of an incident surface and a reflection surface is arranged on an incident-side surface is disclosed. In this configuration, since a part (shown by broken lines in FIG. 5) of lights incident on the incident surface of a prism passes without being incident on the reflection surface when an angle at which a video light is incident on a screen is small, not only light utilizing efficiency is low but lights not incident on the reflection surface stray and an image is deteriorated.

Then, in Patent Document 2, as shown in FIG. 6, technique is disclosed where a prism row constituted by three surfaces is arranged, the three surfaces are equivalent to an incident surface that refracts an incident light from a light source, a reflection surface that totally reflects at least a part of the lights refracted on the incident surface and a rise surface proper to a Fresnel periodic structure, and light utilizing efficiency is enhanced even if an angle at which a video light is incident on a screen is large. The rise surface is formed in parallel with a perpendicular of a lens sheet or with the rise surface tilted by approximately 6 degrees in a forward direction so as to facilitate mold release. In FIG. 5, a normal incident light is shown by a full line, after the normal incident light is refracted on the incident surface, it is reflected on the total reflection surface, and is exiting as desired light parallel to an optical axis.

However, in the above-mentioned structure, since a part (shown by a broken line in FIG. 6) of incident lights is directly incident on the rise surface when an incident angle is small, there occurs a problem that the light is refracted in a direction different from a proper direction and is further reflected on the total reflection surface in a direction different from a proper direction.

To lighten the problem, in Patent Documents 3 and 4, it is proposed that a total reflection type Fresnel lens surface and an incident surface refraction type Fresnel lens surface are combined and are used for a complex surface. FIG. 7 is a sectional view showing the complex surface. This method also has a problem that a light shown by a broken line is directly incident on a rise surface and is exiting in a direction different from a proper direction. When lights are locally exiting in a direction different from a proper direction, there occurs a problem that the quality of an image projected on a screen is deteriorated and interference such as a ghost is caused.

[Patent document 1] JP-A No. 208041/1986

[Patent document 2] JP-A No. 277935/1986

[Patent document 3] International published unexamined patent application No. WO2002/027399

[Patent document 4] JP-A No. 114481/2003

### DISCLOSURE OF THE INVENTION

### Problem to be Solved by the Invention

The object of the invention is to improve light utilizing efficiency and to reduce a stray light caused because the stray light is incident on a rise surface and is reflected or refracted on a reflection surface in an abnormal direction.

### Means for Solving the Problem

The invention for solving the above-mentioned problems is based upon a Fresnel lens sheet used for a rear projection type screen, and the Fresnel lens sheet is characterized in that a prism row for deflecting an incident light on an exit side is arranged on an incident-side surface of the Fresnel lens sheet, at least a part of the prism row is provided with an incident surface for refracting an incident light from a light source, a reflection surface for totally reflecting the light refracted on the incident surface and a rise surface between a center-side terminal point of the incident surface and an outer periphery-side terminal point of the reflection surface, one unit of prism is constituted by three surface of the incident surface, the reflection surface and the rise surface, the rise surface is reversely tilted toward the outer periphery side in at least an innermost of the lens sheet with a crossing point of the incident surface and the rise surface as a base point and a center of an optical axis of the Fresnel lens is eccentric outside the lens sheet.

Besides, the invention is characterized in that a pitch in an innermost of the prism row on the Fresnel lens sheet is smaller than a pitch on an outermost periphery.

In addition, the invention is based upon the above-mentioned Fresnel lens sheet and is characterized in that a reversely tilted angle θ between the rise surface and a perpendicular of the Fresnel lens sheet is equal to or larger than 2 degree and is equal to or smaller than 20 degrees.

Further, the invention is based upon the above-mentioned Fresnel lens sheet, is characterized in that a reinforcing part is arranged between the rise surface and the reflection surface, and is also characterized in that a width of the reinforcing part is equal to or larger than 3 μm and is equal to or smaller than 20 μm.

Furthermore, the invention is characterized in a rear projection type screen provided with the above-mentioned Fresnel lens sheet and a light diffusing sheet and is characterized in a rear projection type image display unit provided with the rear projection type screen.

### EFFECT OF THE INVENTION

According to the above-mentioned invention, the light utilizing efficiency of the Fresnel lens is enhanced, compared with the conventional type where the rise surface is tilted vertically or in a forward direction, the local nonuniformity of an image is reduced, and the quality of an image can be enhanced. Further, as the width of the reinforcing part can be also secured, the production of a cutting tool and a mold can be facilitated. In addition, mold release in molding is facilitated and the productivity can be enhanced.

### BEST MODE FOR CARRYING OUT THE INVENTION

Referring to the drawings, the invention will be described below.

FIG. 6 is a main part sectional schematic drawing showing one example of a Fresnel lens sheet equivalent to the prior art. A prism unit 10 configured by an incident surface 11 having a predetermined angle of refraction y to an optical axis of the Fresnel lens sheet, a total reflection surface 12 having a predetermined angle of reflection p to the optical axis of the Fresnel lens sheet and a rise surface 13 for forming Fresnel structure is arranged on the side of a light source of the Fresnel lens sheet. A valley 21 of the reflection surface and a valley 24 of the rise surface coincide.

After a light incident on the incident surface 11 is refracted on an interface and is totally reflected on the reflection surface 12, it is exiting in a predetermined direction. The predetermined direction means a direction substantially parallel to a normal of a reference surface 14 of the Fresnel lens sheet. In the meantime, as a light incident on the rise surface 13 does not reach the reflection surface 12 or is reflected on the reflection surface 12 in an abnormal direction except the predetermined direction, it cannot be effectively utilized.

FIG. 4 is a perspective view showing a Fresnel lens sheet according to the invention. As shown in FIG. 4, a reference numeral 115 denotes the center of an optical axis and a rectangular part shown by a reference numeral 113 is equivalent to the lens sheet used in the invention. Heretofore, the center of an optical axis of a Fresnel lens is matched with the substantial center of a lens sheet, while in the invention, the center of the optical axis of a Fresnel lens is completely eccentric outside the lens sheet. FIG. 3 is a side view showing the whole projection system. As also known from FIG. 3, the center of the optical axis of the Fresnel lens is made completely eccentric outside the lens sheet.

FIG. 1 is a sectional view showing a local part in one example of an embodiment of the invention. The prism unit 10 according to the invention is formed in a state in which the rise surface 13 is tilted by a rise angle θ toward the outer periphery side from a normal 13′ of a reference surface 14 of the Fresnel lens sheet, compared with the example of the conventional type shown in FIG. 6. Further, the prism unit 10 and an adjacent prism unit 10′ are arranged so that a valley 24 of the rise surface and a valley 21 of a reflection surface of the prism unit 10′ adjacent on the side of the center of the optical axis of the lens sheet are overlapped. Hereby, they are arranged so that prism pitch on the Fresnel lens sheet is smaller than that in the prior art shown in FIG. 6.

As such a form is adopted in the invention, a rate of lights incident on the rise surface 13 out of lights incident on a unit prism can be reduced, compared with that in the example of the prior art and light utilizing efficiency can be enhanced. Simultaneously, as lights incident on the rise surface are reduced, the local nonuniformity of a screen and the interference of a ghost image are reduced and the quality of images can be enhanced.

It was taken for granted that such reversely tilted configuration could not be adopted because mold release was impossible in the prior art where the center of the optical axis of the Fresnel lens existed in the Fresnel lens sheet. However, the inventors found that when the center of the optical axis existed outside the Fresnel lens sheet, the Fresnel lens sheet could be easily released from a mold by releasing it along the rise surface in releasing the molded Fresnel lens sheet and made the invention.

The invention requires that the rise surface is reversely tilted toward the outer periphery side with a crossing point of the incident surface and the rise surface as a base point, and it is desirable to increase its effect that a reversely tilted angle θ is 2 or more degrees. A desirable upper limit value of the reversely tilted angle θ is 20 degrees. When the reversely tilted angle θ is larger than 20 degrees, an angle between the reflection surface 12 and the rise surface 13 is too small, possibly leading to a problem in the durability of a cutting tool for cutting a mold and the durability of the mold and a problem in the mold release of the mold and a molded article.

FIG. 2 is a sectional view showing a local part in another example of the invention. FIG. 2 shows that a reinforcing part 25 is provided between a valley 24 of a rise surface of the prism unit 10 and a valley 21 of a reflection surface of the adjacent prism unit 10′. A defect of inclination in manufacturing a convex portion equivalent to a boundary between adjacent prisms of a metal mold can be prevented by providing the reinforcing part 25 and the effect of enhancing the life of the metal mold is acquired. It is desirable that the width of the reinforcing part 25 is equal to or larger than 3 μm and is equal to or smaller than 20 μm. When the width of the reinforcing part 25 is larger than 20 μm, a rate of lights incident on the rise surface 13 increases and light utilizing efficiency may decrease. When the width of the reinforcing part 25 is smaller than 3 μm, the effect of providing the reinforcing part 25 cannot be sufficiently acquired.

In the invention, a prism row configured as described above may also be used on an overall Fresnel lens sheet or may also be used on a part. The reason will be described below.

As shown in FIG. 3, since an incident angle α between a normal of a lens reference surface 14 of the Fresnel lens sheet and an incident light 100 is large on the outer periphery side of the Fresnel lens sheet, there is an area where a rate of lights incident on the rise surface decreases and such lights do not exist. When these are considered, the cutting of the mold is facilitated and the release of the mold and a molded article can be improved respectively by applying the invention to only the vicinity of the center of an optical axis of the Fresnel lens, that is, the vicinity of the innermost and setting the inclination of the rise angle α on the outer periphery side of the Fresnel lens so that the rise surface is tilted in a forward direction as in the prior art inside with a crossing point of an incident surface and the rise surface as a base point for example. It is desirable that a rise angle varies gradually or continuously depending upon a position.

It is desirable for the similar reason that the width of the reinforcing part varies gradually or continuously depending upon a position. The production of the mold is facilitated and the transmissivity of the whole surface of the Fresnel lens can be made uniform respectively by setting the width of the reinforcing part in the vicinity of the center of the optical axis of the Fresnel lens so that the width is smaller than the width of the reinforcing part on the outer periphery side of the Fresnel lens for example.

It is desirable further for the similar reason that pitch in the vicinity of the optical axis in a prism row on the Fresnel lens sheet is smaller than pitch on the outermost periphery. This is effective in facilitating the production of the mold and in making the transmissivity of the whole surface of the Fresnel lens sheet uniform.

The Fresnel lens sheet according to the invention may also be a linear Fresnel lens sheet where a prism row is linear and may also be a concentric circular Fresnel lens sheet. When the Fresnel lens sheet is linear, an optical axis of the Fresnel lens is parallel to a longitudinal direction of a prism row.

The Fresnel lens sheet according to the invention can be manufactured by a molding method such as casting using ultraviolet hardening resin and press molding and for the material of its substrate, optical materials such as glass and transparent resin can be used. When the lightening of a product is regarded as important, it is desirable that a transparent resin member is used. In the meantime, when the solution of a problem of a warp by the influence of ambient temperature and humidity of the Fresnel lens sheet is regarded as important, it is desirable that a glass member is used.

### EMBODIMENTS

The effect of the invention will be described using embodiments and comparative examples below. In the embodiments and the comparative examples, an angle of an exiting light with an optical axis of a Fresnel lens sheet is 0 degree, that is, the exiting light is parallel to the optical axis, a prism apical angle β between an incident surface 11 and a reflection surface 12 is set to 50 degrees, the length of the incident surface 11 is set to 0.04 mm, and the refractive index of lens material is set to 1.55.

### Embodiment 1

An incident angle α is set to 23 degrees, a prism pitch is set to 0.0525 mm, an angle of an incident surface is set to 31.8 degrees, an angle μ of a reflection surface is set to 18.2 degrees, and an angle θ of a reversely tilted rise surface is set to 5 degrees. A rate of exiting lights is 63.6%.

### Comparative Example 1

A prism row is arranged as in Embodiment 1 except that an angle θ of a rise surface is set to 0 degree and a prism pitch is set to 0.060 mm. At this time, a rate of lights exiting as parallel lights is 56.0%.

Next, an embodiment and a comparative example where prism units are connected via a minute flat part will be described.

### Embodiment 2

An incident angle α is set to 23 degrees, an angle of an incident surface is set to 31.8 degrees, an angle μ of a reflection surface is set to 18.2 degrees, a prism pitch is set to 0.0526 mm, a width W of a reinforcing part is set to 0.006 mm, and an angle θ of a reversely tilted rise surface is set to 5 degrees. A rate of exiting lights is 57.0%.

### Comparative Example 2

A prism row is arranged as in Embodiment 2 except that an angle θ of a rise surface is set to 0 degree and prism pitch is set to 0.066 mm. At this time, a rate of lights exiting as parallel lights is 50.5%.

Examples that an incident angle α is set to 23° and 46°, the width of a reinforcing part is varied from 0 to 15 μm and an angle of a reversely tilted rise surface is varied from 0° to 15° including the embodiments and the comparative examples respectively described above are shown in Tables 1 and 2.

TABLE 1

| | Reinforcing part width (mm) | | | | |
|---|---|---|---|---|---|
| Rise angle θ | 0.000 | 0.003 | 0.006 | 0.010 | 0.015 |
| 0° | 56.0 | 53.2 | 50.3 | 47.5 | 44.6 |
| 5° | 63.6 | 59.8 | 57.0 | 53.2 | 49.4 |
| 7° | 67.4 | 63.6 | 59.8 | 56.0 | 52.2 |
| 10° | 74.1 | 69.3 | 65.5 | 60.8 | 56.0 |
| 15° | 90.2 | 83.6 | 77.9 | 71.2 | 64.6 |

TABLE 2

| | Reinforcing part width (mm) | | | | |
|---|---|---|---|---|---|
| Rise angle θ | 0.000 | 0.003 | 0.006 | 0.010 | 0.015 |
| 0° | 83.9 | 80.0 | 76.2 | 72.4 | 68.6 |
| 5° | 91.5 | 86.7 | 81.9 | 77.4 | 72.4 |
| 7° | 94.3 | 89.6 | 84.8 | 79.1 | 74.3 |
| 10° | 95.3 | 93.4 | 88.6 | 82.9 | 77.2 |
| 15° | 95.3 | 95.3 | 95.3 | 90.5 | 82.9 |

For example, in the table 1, in the example of the prior art where an angle of the rise surface is 0 degree when the width of the reinforcing part is 0.000 mm, the transmissivity is 56.0%, while in the example of the invention where angles of the reversely tilted rise surface are 5, 7 and 10 degrees, respective transmissivity are 63.6%, 67.4% and 74.1%, and it is known that the efficiency of transmission increases.

In addition, in the example of the invention where the width of the reinforcing part is 0.010 mm and an angle of the rise surface is 7 degrees, the transmissivity is 56.0%. Therefore, as the width of the reinforcing part can be set to 0.010 mm though the efficiency of transmission is similar to that in the prior art, the production of the mold is facilitated and the durability of the mold is improved.

Further, in the example of the invention where the width of the reinforcing part is set to 0.003 mm and an angle of the rise surface is 7 degrees, the transmissivity is 63.6%. Therefore, as the length of the flat part can be secured though the higher efficiency of transmission is acquired, compared with that in the prior art, the production of the mold is facilitated and the durability of the mold is improved.

### BRIEF DESCRIPTION OF THE DRAWINGS

FIG. 1 A local sectional view showing one example of a prism lens sheet according to the invention.

FIG. 2 A local sectional view showing one example of the prism lens sheet according to the invention.

FIG. 3 A side view showing a projection system of a rear projection type image display unit according to the invention.

FIG. 4 A perspective view showing the prism lens sheet according to the invention.

FIG. 5 A local sectional view showing a prism lens sheet according to prior art.

FIG. 6 A local sectional view showing a prism lens sheet according to prior art.

FIG. 7 A local sectional view showing a prism lens sheet according to prior art.

FIG. 8 A side view showing a projection system of a rear projection type image display unit according to prior art.

FIG. 9 A perspective view showing the prism lens sheet according to the prior art.

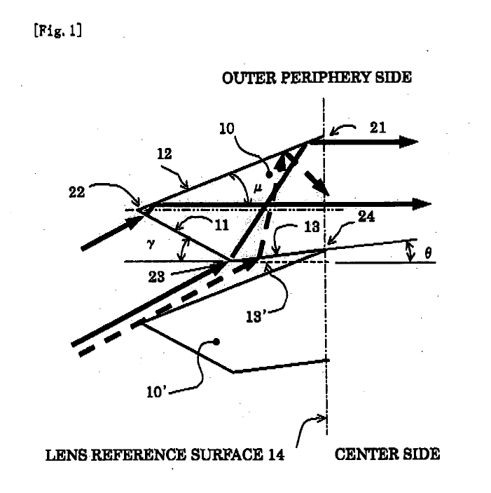

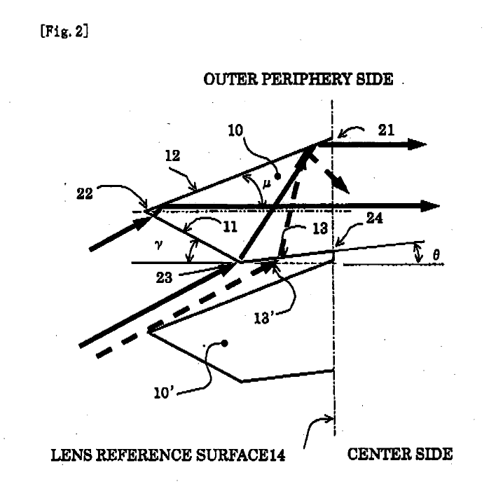

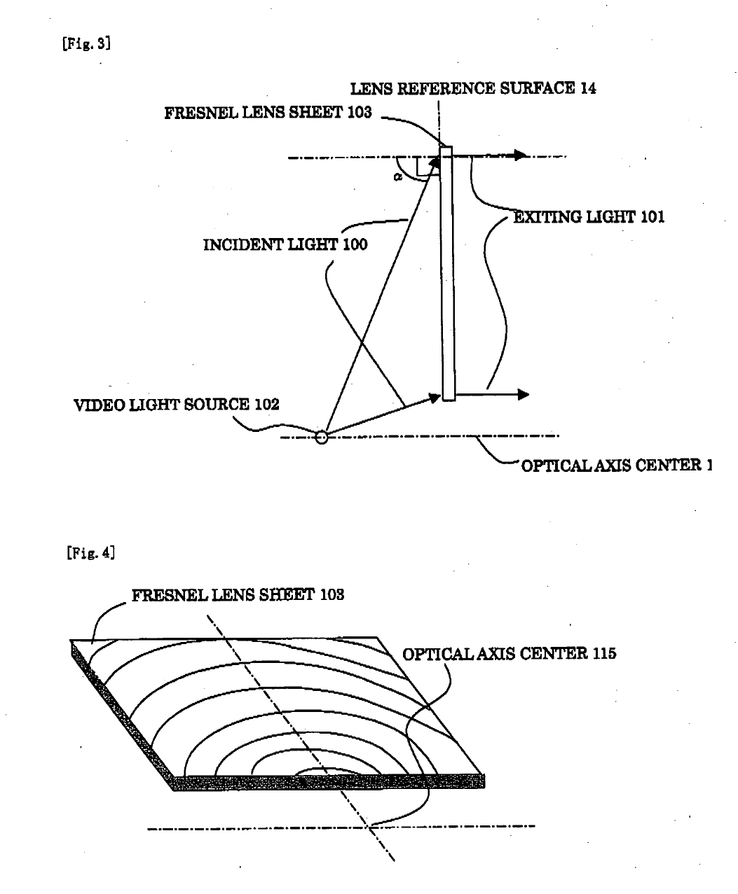

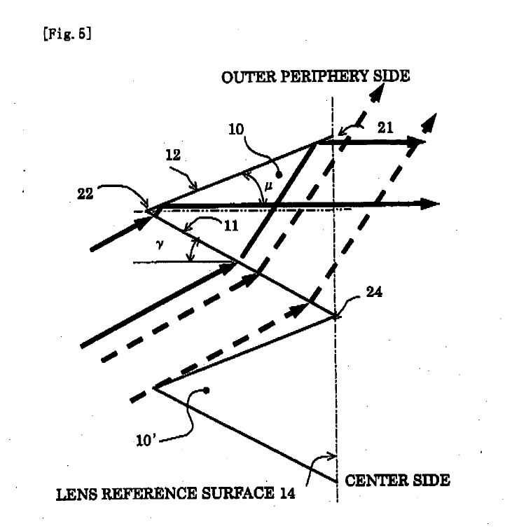

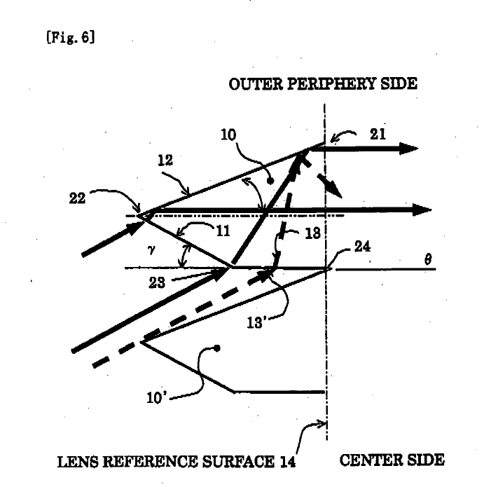

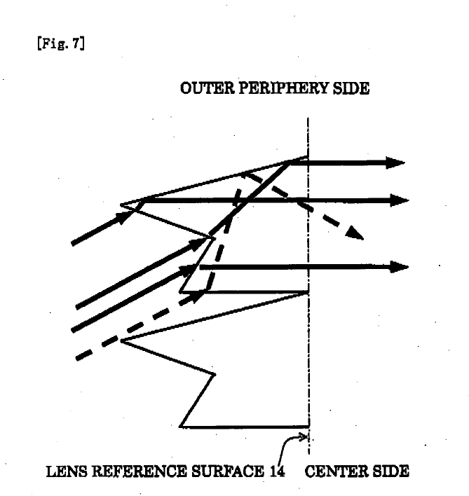

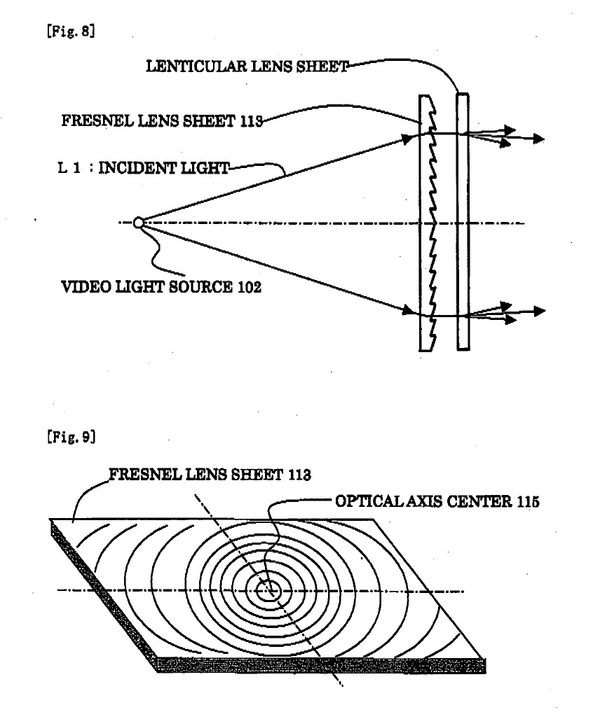

### DESCRIPTION OF REFERENCE NUMERALS

10, 10′: Prism unit, 11: Incident surface, 12: Reflection surface, 13: Rise surface
14: Lens reference surface
100: Incident light, 101: Exiting light, 102: Video light source
103, 113: Fresnel lens sheet, 115: Optical axis center

1. A Fresnel lens sheet used for a rear projection type screen, comprising
a prism row arranged on an incident-side surface of the Fresnel lens sheet for deflecting an incident light on an exit side,
wherein at least a part of the prism row is provided with an incident surface for refracting an incident light from a light source, a reflection surface for totally reflecting the light refracted on the incident surface and a rise surface between a terminal point on a center side of the incident surface and a terminal point on an outer periphery side of the reflection surface;
one unit of prism is constituted by three surfaces of the reflection surface, the incident surface and the rise surface;
the rise surface is reversely tilted toward the outer periphery side in at least an innermost of the lens sheet with a crossing point of the incident surface and the rise surface as a base point; and
a center of an optical axis of the Fresnel lens is eccentric outside the lens sheet.

2. The Fresnel lens sheet according to claim 1,
wherein a pitch in an innermost of the prism row on the Fresnel lens sheet is smaller than a pitch on an outermost periphery.

3. The Fresnel lens sheet according to claim 1 or 2,
wherein a reversely tilted angle θ between the rise surface and a perpendicular of the Fresnel lens sheet is equal to or larger than 2 degrees and is equal to or smaller than 20 degrees.

4. The Fresnel lens sheet according to any of claims 1 to 3,
wherein a reinforcing part is arranged between the rise surface and the reflection surface.

5. The Fresnel lens sheet according to claim 4, wherein a width of the reinforcing part is equal to or larger than 3 μm and is equal to or smaller than 20 μm.

6. A rear projection type screen, comprising:
the Fresnel lens sheet according to any of claims 1 to 5; and
a light diffusing sheet.

7. The rear projection type screen according to claim 6, wherein the light diffusing sheet is formed by a lenticular lens sheet on which longitudinally longer semicylindrical lenses are arrayed on a light incident surface.

8. A rear projection type image display unit, comprising the rear projection type screen according to claim 6.
